(19) United States
(12) Patent Application Publication
(10) Pub. No.: US 2018/0229746 A1
(43) Pub. Date: Aug. 16, 2018

(54) HANDLE CLIP MECHANISM

(71) Applicant: Wal-Mart Stores, Inc., Bentonville, AR (US)

(72) Inventor: Yurgis Mauro Bacallao, Centerton, AR (US)

(21) Appl. No.: 15/879,786

(22) Filed: Jan. 25, 2018

Related U.S. Application Data
(60) Provisional application No. 62/457,526, filed on Feb. 10, 2017.

(51) Int. Cl. B62B 3/02; F16M 11/04; F16M 13/02; B62B 3/00; B62B 3/14

(52) U.S. Cl. CPC B62B 3/02; F16M 11/041; F16M 2200/02; B62B 3/001; B62B 3/1428; F16M 13/02

(57) ABSTRACT

A coupling device for removably attaching a mobile computing device having a display to a shopping cart handle comprises: a clip mechanism configured to removably couple to a shopping cart handle; a handle grip unit extending tangentially from the clip; a top surface of the handle grip unit constructed and arranged to receive and hold in place a mobile computing device having a display, the handle grip unit permitting a user to orient, rotate, or angle the coupling device, and therefore, the display of the mobile computing device, about the shopping cart handle while providing a steady grip so that the user can move the shopping cart without the mobile computing device falling off the shopping cart. The top surface has a width that is greater than a main body of the handle grip unit to directly couple with a region of the mobile computing device directly under a display of the mobile computing device.

### RELATED APPLICATIONS

This application claims the benefit of U.S. Provisional Patent Application No. 62/457,526, filed Feb. 10, 2017 and entitled “Handle Clip Mechanism”, the contents of which are incorporated herein in their entirety. This application is related to U.S. Design Pat. Application No. 29/593,683 filed Feb. 10, 2017 and entitled “Handle Clip Mechanism”, the contents of which are incorporated herein in their entirety.

### TECHNICAL FIELD

The present inventive concepts relate generally to holders for portable computing devices in a shopping environment, and more specifically, to a clip mechanism for securing a portable computing device cradle to a handle of a shopping cart.

### BACKGROUND

Retail establishments such as supermarkets, department stores, or other stores continue to seek solutions for improving a customer experience, for example, by implementing technology to reduce long lines at a checkout.

Portable computing devices such as smartphones, computing tablets, scanning devices, or the like may provide useful tools for retail store customers. For example, portable scanning devices, either supplied by the store or performed by a customer smartphone or the like, can be used by customers to obtain product information, track purchases, and/or pay for purchases.

It is desirable for such portable computing devices configured to provide shopping-related functions to be securely coupled to a shopping cart or other carrying apparatus so that the customer can push the cart while operating the device in a hands-free manner.

### SUMMARY

In one aspect, provided is a coupling device for removably attaching a mobile computing device having a display to a shopping cart handle, the coupling device comprising: a clip mechanism configured to removably couple to a shopping cart handle; a handle grip unit extending tangentially from the clip; a top surface of the handle grip unit constructed and arranged to receive and hold in place a mobile computing device having a display, the handle grip unit permitting a user to orient, rotate, or angle the coupling device, and therefore, the display of the mobile computing device, about the shopping cart handle while providing a steady grip so that the user can move the shopping cart without the mobile computing device falling off the shopping cart the top surface having a width that is greater than a main body of the handle grip unit to directly couple with a region of the mobile computing device directly under a display of the mobile computing device.

In another aspect, provided is a portable computing device holder, comprising a clip mechanism configured to removably couple to a tubular element; a handle grip unit extending tangentially from the clip; and a coupler extension extending from the handle grip unit, a top surface of the handle grip unit constructed and arranged to receive and hold in place a mobile computing device having a display, the handle grip unit permitting a user to orient, rotate, or angle the coupling device, and therefore, the display of the mobile computing device, about the tubular element, the top surface having a width that is greater than a main body at a distal end of the handle grip unit to directly couple with a region of the mobile computing device directly under the display of the mobile computing device.

In another aspect, provided is a method for coupling a portable computing device to a shopping cart handle, comprising: assembling a scanning device; coupling a handle body of a handle clip mechanism to the scanning device; and coupling a coupler of the handle clip mechanism to the shopping cart handle.

### BRIEF DESCRIPTION OF THE DRAWINGS

Advantages of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 is a perspective view of a portable computing device holder removably coupled to a shopping cart, in accordance with some embodiments.

FIG. 2 is a perspective view of a shopping cart handle clip mechanism, in accordance with some embodiments.

FIG. 3 is another perspective view of the shopping cart handle clip mechanism of FIG. 2

FIG. 4 is a front view of the shopping cart handle clip mechanism of FIGS. 2 and 3.

FIG. 5 is a side view of the shopping cart handle clip mechanism of FIGS. 2-4.

FIG. 6 illustrates a method for coupling a portable computing device to a shopping cart handle, in accordance with some embodiments.

### DETAILED DESCRIPTION OF EMBODIMENTS

As discussed above, embodiments of the present invention relate to holders for portable computing devices in a shopping environment, and more specifically, to a clip mechanism for securing a portable computing device cradle to a handle of a shopping cart.

The clip mechanism is part of a handle attachment that assists with maintaining portable computing devices having displays in a stationary position and oriented so that a shopper can have a line of sight view of the display. Such portable computing devices may be a personal smartphone, electronic notebook, tablet computing device, scanner wand, or any other type of device with a computer processor and screen for providing an electronic display.

The clip mechanism removably attaches a portable computing device to a shopping cart handle, and supports the portable device during movement of the cart so that the portable device does not fall off the cart or otherwise remains rigidly coupled to the handle during movement of the shopping cart so that the user can operate the portable computing device. In addition to the clip mechanism, the coupling device may comprise a handle grip unit extending tangentially from the clip. A top surface of the handle grip unit constructed and arranged to receive and hold in place the mobile computing device. The handle grip unit permits a user to orient, rotate, or angle the coupling device, and therefore, the display of the mobile computing device, about the shopping cart handle while providing a steady grip so that the user can move the shopping cart without the mobile computing device falling off the shopping cart.

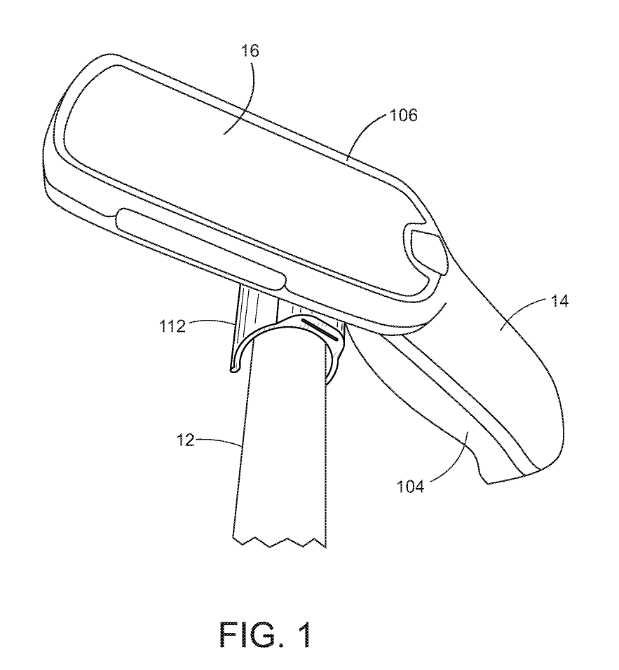

FIG. 1 is a perspective view of a portable computing device 14 removably coupled to a shopping cart by a shopping cart handle clip mechanism 104, in accordance with some embodiments. As shown in FIG. 1, the handle clip mechanism 104 is coupled between the portable computing device 14 and a handlebar 12 of a shopping cart, but not limited thereto. For example, the handle clip mechanism 104 can be coupled to any rod-shaped handle or rail, such as the handle of a flatbed-type cart or a rail extending from a shopping cart, for example, but not by way of limitation. The handle clip mechanism 104 may be constructed and arranged to couple to a bottom region of the portable computing device 14, for example, which may include batteries, electronic components, or the like, and to also serve as a cover for these components. Alternatively, the handle clip mechanism 104 may couple to both a handle and bottom portion of the portable device 14 and to also couple to the handlebar 12. In some embodiments, the handle clip mechanism 104 replaces a bottom cover of the portable computing device 14 and therefore has a shape and configuration that permits the handle clip mechanism 104 to directly couple to a portable device cover 106, or other frame or main portion of the portable computing device 14. Here, batteries, electronic circuits, and so on inside the device cover 106 may be exposed by the absence of a bottom cover. However, the handle clip mechanism 104 is constructed and arranged to conform with the device cover 106 to cover and protect internal components of the portable computing device 14. In other embodiments, the handle clip mechanism 104 couples to the bottom surface of the portable computing device 14, for example, a computing device have a monolithic body and no removable bottom cover.

In some embodiments, the portable computing device 14 is a store-provided scanning device that permits customers to scan items as they're shopping. For example, portable scanning devices are loaned to customers in some stores so that the customers can scan and electronically pay for their purchases while they shop. The mobile computing device 14 may alternatively or additionally be any type of mobile device such as a smart phone, a tablet computing device, a scanner, a camera, a calculator, a music or video device, a mobile computer, computing tablet or pad, portable computer, global positioning system device, portable digital assistant, or any other type of portable computing device, and can perform a number of computing functions related to a shopping application such as point of sale (POS) functions. The handle clip mechanism 104 can also hold non-computing devices such as a notepad or a voice recorder, or any other mobile device.

The portable computing device 14 may have a display 16 that is held in place and oriented by the handle clip mechanism 104 so that a shopper can have a line of sight view of the device display 16. The handle clip mechanism 104 may allow some force to orient the portable computing device 14 until it is positioned in a desirable location. However, the handle clip mechanism is sufficiently secured to the handlebar 12 to prevent unexpected or undesirable rotation during a movement of the shopping cart, for example, during a shopping trip by a user.

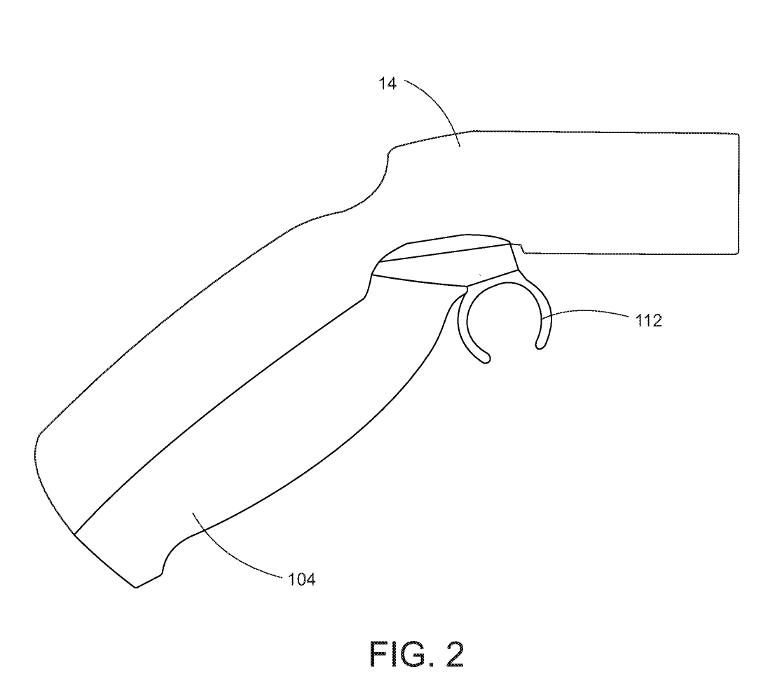

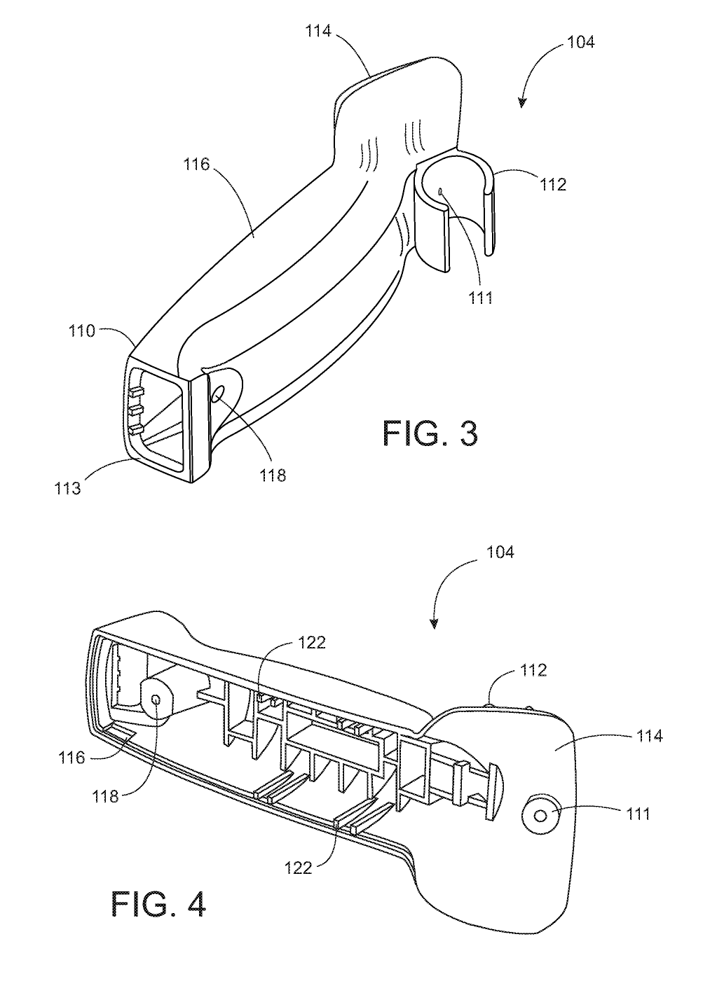

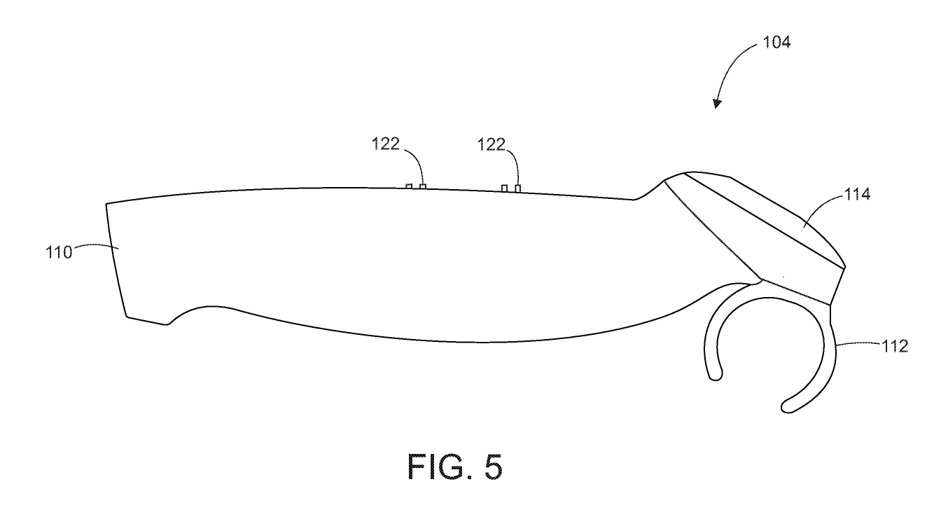

FIG. 2 is a perspective view of a shopping cart handle clip mechanism 104, in accordance with some embodiments. FIG. 3 is another perspective view of the shopping cart handle clip mechanism 104 of FIG. 2. FIG. 4 is a front view of the shopping cart handle clip mechanism 104 of FIGS. 2 and 3. FIG. 5 is a side view of the shopping cart handle clip mechanism 104 of FIGS. 2-4. In some embodiments, as shown, the handle clip mechanism 104 may be removably attached as a separate physical component to the portable computing device 14, for example, housing 106 shown in FIG. 1. In other embodiments, the handle clip mechanism 104 is integral with the body or housing of the portable computing device 14, for example, formed of a same stock of molded plastic or other material. Here, the handle clip mechanism 104 may include a separate battery cover or the like for access to components at a bottom region of the portable computing device 14, such as batteries or other replaceable components.

In some embodiments, as shown in FIGS. 2-5, the shopping cart handle clip mechanism 104 (also referred to as a coupling device) includes a handle body 110, a handle coupler 112 (also referred to as clip), and a coupler extension 114. The handle body 110 includes a top surface 116 on which the portable computing device 14 may be positioned. In particular, a back surface of the computing device 14 may directly abut the top surface 116 so that the front side of the portable computing device 14 including the display 16 is viewable to a user.

In some embodiments, the interior of the handle body 110 of the handle clip mechanism 104 includes electronic devices, batteries, or the like, or covers such components in the bottom region of the computing device 14. The display 16 of the mobile computing device 14 is on the opposite side as the bottom region to which the clip mechanism 104 is coupled, so that the handle coupler 112 removably attaches to the handlebar 12 and also permits the display 16 to be presented to a viewer.

In embodiments that include a standalone or separate handle clip mechanism 104 (distinguished from an integral handle clip mechanism 104), the handle body 110 is constructed and arranged to couple to a housing, frame, or other structural feature of the mobile computing device 14, for covering batteries, electronic components, or the like of the mobile computing device 14. In doing so, the handle body 110 includes at least one hole 118 for receiving a screw or other or other fastening components for coupling the handle clip mechanism 104 to the mobile computing device 14. In some embodiments, a combination of clips 122, screws or other fastening devices through the hole(s) 118, and hole 111 may be provided for coupling the portable device 14 to the handle clip mechanism 104, and/or using bonding agents, adhesives, or the like. The holes 118 are located at positions that do not interfere with the location of the internal components of the portable device 14. As shown in FIG. 4, the interior of the handle clip mechanism 104 may include a plurality of regions that are formed by walls formed as part of the same mold or unitary stock forming the handle clip mechanism. These regions may be constructed and arranged for positioning about particular components of the portable device 14, such as a battery, computer chip(s) and so on.

In some embodiments, the handle body 110 has an opening 113 at a distal end of the handle body 110 opposite the coupler extension 114 at the proximal end, for exposing electrical components of the portable device 14, for example, a power cord plug, battery insert, and so on. This permits external components such as a power cord, wired communications element such as an Ethernet cable or the like to be plugged into the portable device 14 via the distal end opening 113.

The coupler extension 114 extends from the proximal end of the handle body 110. In some embodiments, the coupler extension 114 and handle body 110 is integral, or unitary, for example, molded or machined from a single stock. In other embodiments, the coupler extension 114 and handle body 110 are formed separately and coupled together using adhesives, mating devices, or other well-known coupling techniques. The coupler extension 114 may include at least one hole 111 for receiving a screw (not shown) or other coupling mechanism for coupling the coupler extension 114 to the handle coupler 112.

The coupler extension 114 extends from the handle body 110 at an angle. The angle of the coupler extension 114 relative to the handle body 110 has a characteristic in that a substantially flat portable computing device 14 may have a display region 16 seated on the coupler extension 114 and a handle or other element of the coupler extension 114 may be positioned on the handle body 110. The angle between the coupler extension 114 and the handle body 110 and the corresponding bend at this region permits the device display 16 to be oriented in a direction of a viewer standing over the portable computing device 114, for example, holding onto the handlebar 12 while facing the display 16. Also, the coupling extension 114 may extend from the handle body 110 as shown in FIG. 2 to mate with a recess region or the like in the portable device 14. The coupling mechanism 114 may have a width that is greater than that of the distal end 113 in order to accommodate the handle coupler 112 and to securely attach to a region of the portable device 14 that is sufficiently wide to support the display 16. The handle clip mechanism 104 preferably has a length that is less than an overall length of the portable device 14, so that the proximal end of the handle clip mechanism 104 including the coupler extension 114 couples to a mid-portion of the portable device 14, i.e., at the bend between the body 110 and the extension 114.

As described herein, the handle coupler 112 couples handle clip mechanism 104 to handle 12 of the shopping cart. Handle coupler 112 may have a C-shaped cross-section, as seen in FIGS. 1-5, to include an opening so that the handle coupler 112 so that the handle coupler 112 partially encircles handle. In some embodiments, the handle coupler 112 form a circular, oval, arc, semi-circle, or horseshoe shaped or other relevant shaped interior that surrounds a cross-sectional region of a shopping cart handle 12 or other tubular element and applies a force against the shopping cart element so as to not move, e.g., rotate about the shopping cart handle. In particular, the inner surface has a curvature dimensioned to match an outer curvature of the handlebar or other tubular element. When secured about the handlebar, the coupler 112 operates to induce a radially inward force on the inner surface of the coupler. The coupler 112 may be formed by an outer clip component and an inner clip component that interlock with each other about a handlebar or other tubular apparatus. The interior of the outer clip component and an inner clip component can be curved for positioning about a handlebar or other tubular structure.

The handle coupler 112 may be integral with the coupler extension 114, for example, unitary, single piece of material, or the like, or the handle coupler 112 may be coupled to the coupler extension 114 by holes aligned in the handle coupler 112 and coupler extension for insertion of a screw or other coupling mechanism, or using bonding agents, adhesives, or the like. The location of the handle coupler 112 extending from the coupling extension 114, which in turn is positioned under the display 16 of the portable device 14 provides for precise user-defined positioning of the display 16 and orientation relative to the shopping cart handlebar 12 based on the user's preferences.

The handle coupler 112 forms a circular, oval, or other relevant shaped interior that surrounds a cross-sectional region of a shopping cart handle or other tubular element and applies a force against the shopping cart element so as to not move, e.g., rotate about the shopping cart handle. The interior of the handle coupler 112 at least partially surround the handle may include a foam lining or other padding material that provides friction or grip between the coupler 112 and the handle to prevent or reduce rotation about the handle.

In some embodiments, the handle coupler 112 may be a self-locking clip mechanism, for example, for example, U.S. Patent Application No. 62/440,713 filed Dec. 30, 2016, entitled “Self-Locking Clip Mechanism,” the contents of which are incorporated by reference herein in their entirety.

The handle coupler 112 may be formed of metal, plastic, or other rigid continuous one-piece material having the strength, durability, and other characteristics sufficient for securing a portable computing device 14 to the tubular structure 12, in particular, some elasticity so that the ends of the handle coupler 112 can expand to widen an opening to fit around a tubular object such as a shopping cart handlebar 12. In some embodiments, the coupler 112 extends from a distal end of the coupler extension 114. The location of the coupler 112 in this manner permits a configuration to pivot the device display 16 about an axis extending along the direction of the handlebar 12 in a direction of a viewer holding the shopping cart handlebar 12 on either side of the portable device 14 coupled to the handle, or to slide the device display 16 along the axis of the handlebar 12. Some portable devices such as the scanner shown in FIGS. 1 and 2 have a first portion that is positioned in a horizontal direction, and a second portion holding a battery, electronics, and so on. This second portion may extend tangentially from the first portion. The handle clip mechanism 104 includes the body 110 and extension 114 likewise configured to contour with a portable device having angled portions. For example, the coupler 112 extends from the coupler extension 114, which in turn is coupled to the first, e.g., horizontal, portion of the portable device 14. In another example, the coupler 112 is positioned at an interface between the body 110 and the extension 114 and is at an angle to each of the body 110 and the extension 114. For example, as shown in FIG. 2, the opening of the coupler 112 is at an angle between the horizontal position of the first portion of the portable device 14 and the angled position of the second portable device portion and the clip mechanism body 110. In doing so, the body 110 of the clip mechanism 104 coupled to the second portion of the portable device 14 extends tangentially from the first portion and coupler extension 114. Here, the coupler 112 may serve as a fulcrum between the first portion and second portion of the portable device 14.

In some embodiments, the coupler extension 114 has a flared configuration, where peripheral regions, or wings, extend from the sides of the extension 114 and are wider than the handle body 110. This feature permits the portable device 14 to likewise be wider than the handle body 110. Here, the coupler 112 is configured to be positioned at or near an outermost distal end of the coupler extension 114 to provide stability to the handle clip mechanism 104, and to prevent the handle clip mechanism 104 from inadvertently rotating when the portable device 14 is coupled to the handle and is in operation during a user's shopping experience.

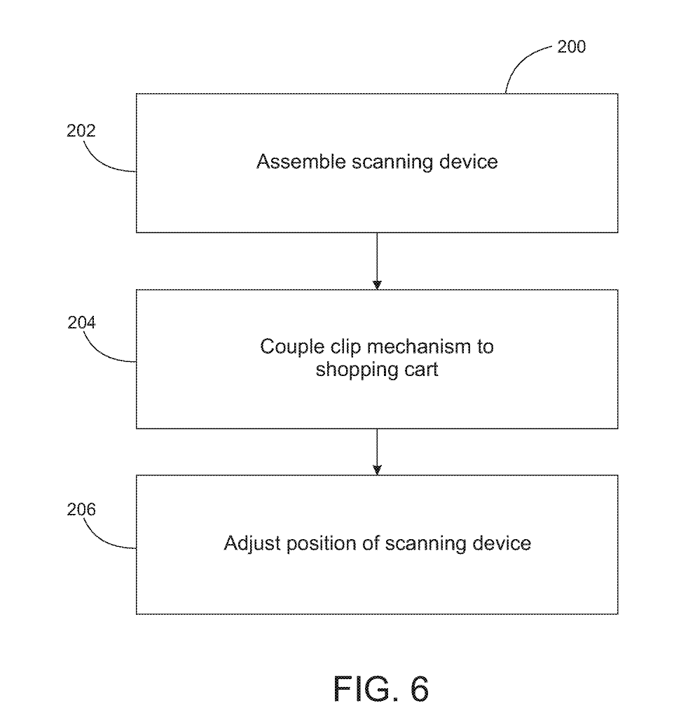

FIG. 6 is a flowchart of a method 200 for coupling a portable computing device 14 to a shopping cart handlebar 12, in accordance with some embodiments. In describing the method 200, reference is made to elements of FIGS. 1-6.

Method 200 includes an act 202 of assembling a scanning device. In doing so, the handle clip mechanism 104 is coupled to, integrated with, or otherwise unitary with the portable computing device 14. Method 200 also includes an act 204 of coupling a clip mechanism, or more specifically, the handle coupler 112 of the clip mechanism 204 to a handlebar, rail, or other elongated object. Method 200 includes an act 206 of orienting or otherwise adjusting the position of the scanning device so that a user can view or otherwise operate the scanning device. Method 200 can include many other acts. In some embodiments, the foregoing steps 202-206 may be performed in a different order.

The descriptions of the various embodiments of the present inventive concepts have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A coupling device for removably attaching a mobile computing device having a display to a shopping cart handle, the coupling device comprising:
a clip mechanism configured to removably couple to a shopping cart handle;
a handle grip unit extending tangentially from the clip; and
a top surface of the handle grip unit constructed and arranged to receive and hold in place a mobile computing device having a display, the handle grip unit permitting a user to orient, rotate, or angle the coupling device, and therefore, the display of the mobile computing device, about the shopping cart handle while providing a steady grip so that the user can move the shopping cart without the mobile computing device falling off the shopping cart, the top surface having a width that is greater than a main body of the handle grip unit to directly couple with a region of the mobile computing device directly under the display of the mobile computing device.

2. The coupling device of claim 1, further comprising a foam lining to grip the clip to the handle.

3. The coupling device of claim 1, further comprising a battery cover lid that is part of the handle grip unit.

4. The coupling device of claim 1, wherein the clip and the battery cover are a single integrated unit.

5. The coupling device of claim 1, wherein the mobile computing device is a scanning device.

6. The coupling device of claim 1, wherein the main body of the handle grip unit is constructed and arranged to cover batteries, electronic components, or other internal elements of the mobile computing device.

7. The coupling device of claim 16, wherein the main body includes at least one hole for receiving a fastening component for coupling the coupling device to the mobile computing device.

8. The coupling device of claim 1, wherein the coupler extension extends from the handle grip unit and is oriented in a direction of extension tangential to the handle grip unit, wherein the clip mechanism extends from a distal end of the coupler extension.

9. The coupling device of claim 1, wherein the coupler extension and handle grip unit are a single integrated unit, formed of a common stock of material.

10. The coupling device of claim 1, wherein the handle grip unit includes at least one hole for receiving a fastening component for coupling the coupling device to the mobile computing device.

11. A portable computing device holder, comprising:
a clip mechanism configured to removably couple to a tubular element;
a handle grip unit extending tangentially from the clip; and
a coupler extension extending from the handle grip unit, a top surface of the handle grip unit constructed and arranged to receive and hold in place a mobile computing device having a display, the handle grip unit permitting a user to orient, rotate, or angle the coupling device, and therefore, the display of the mobile computing device, about the tubular element, the top surface having a width that is greater than a main body at a distal end of the handle grip unit to directly couple with a region of the mobile computing device directly under the display of the mobile computing device.

12. The portable computing device holder of claim 11, wherein the main body of the handle grip unit is constructed and arranged to cover batteries, electronic components, or other internal elements of the mobile computing device.

13. The portable computing device holder of claim 11, wherein the coupler extension extends from a proximal end of the handle grip unit, and is oriented in a direction of extension tangential to the handle grip unit, wherein the clip mechanism extends from a distal end of the coupler extension.

14. A method for coupling a portable computing device to a shopping cart handle, comprising:
assembling a scanning device;
coupling a handle body of a handle clip mechanism to the scanning device; and
coupling a coupler of the handle clip mechanism to the shopping cart handle.

15. The method of claim 14, wherein coupling the handle body to the scanning device includes aligning holes of the handle body and the scanning device with each other, inserting fastening devices through the holes, and applying a force to the fastening devices.

16. The method of claim 14, wherein coupling the handle body to the scanning device includes coupling a clip extending from the handle body to a surface of the scanning device.

17. The method of claim 14, further comprising a coupler extension extending from the handle body, the coupler extension extending in a direction of extension tangential to the handle body.

18. The method of claim 14, wherein coupling the handle body to the scanning device comprises coupling a first portion of the scanning device to the handle body and coupling a second portion of the second device to the handle body, the first and second portions of the scanning device parallel to surfaces of the handle body and coupler extension.
